(19) United States
(12) Patent Application Publication
(10) Pub. No.: US 2006/0214915 A1
(43) Pub. Date: Sep. 28, 2006

(54) Notebook computer with an independent number and operation in putting device

(76) Inventor: Fan Chia Hua, Miau-Li Hsien (TW)

Correspondence Address: FAN CHIA HUA, 235 Chung-Ho, Box 8-24, Taipei, TW

(21) Appl. No.: 11/158,758

(22) Filed: Jun. 23, 2005

(30) Foreign Application Priority Data
Mar. 23, 2005 (TW) 094108902

(51) Int. Cl. G09G 5/00

(52) U.S. Cl. 345/168

(57) ABSTRACT

A notebook computer with an independent number and operation inputting device comprises a mainframe body having a keyboard and a touch panel; two sides of the touch panel being installed with plate portions; a receiving groove of one of the plate portions; an independent number input device being installed in the receiving groove; a touch panel being installed at a top of the number input device; a shaft serving to connect the movable cover to the plate portion. The independent number and operation inputting device includes at least number keys, the operation keys, and keys of “Num Lock”, “Del”, “Enter”, etc. By the independent number input device, it is only necessary to input characters and numbers to the notebook computer alternatively so as to achieve the objective of easy operation and increase typing efficiency.

### FIELD OF THE INVENTION

The present invention relates to notebook computers, and in particular to a notebook computer with an independent number and operation inputting device, wherein the notebook computer is installed with an independent number and operation inputting device serving to input numbers and operation instructions.

### BACKGROUND OF THE INVENTION

Due to technology improvement, computers are becoming required devices for most people in their life and works. Because the trends of 3C products are toward lightness, small-size and thinness, notebook computers with the characters of portability, small-size and economic space has becomes a main trend of computer market year by year, even if the prices of the notebook computer are higher than personal computers. Thus more and more people use notebook computers. According to statistic results, the amount of global sale of notebook computers will be about 550,000 in 2005.

Referring to FIG. 1, a notebook computer 1 of a prior art comprises a mainframe body 2 and a display unit 3. A keyboard 21 and a touch panel 22 are installed in the upside of the mainframe body 2. The display unit 3 is a screen 31. The keyboard 21 of the prior art notebook computer 1 is usually arranged with 88 keys for saving space. However, many people cannot get use to the smaller size of the keyboard 21. Furthermore, comparing with a keyboard of standard personal computer with 104 keys, the keys of the keyboard 21 of the notebook computer 1 are less than the prior art keyboard with a number of about ten keys. The keyboard 21 of the notebook computer 1 reduces the number keys on the right side of the standard keyboard of a personal computer obviously. Thus, several disadvantages appear because of downsizing the standard keyboard of the prior art. When a user inputs both numbers and characters using the keyboard 21, the user must switch continuously from the number input mode to the character input mode. Other than slowly typewriting speed and time being wasted for switching between various modes, the switch often causes typewriting errors.

### SUMMARY OF THE INVENTION

The primary object of the present invention is to provide an independent number and operation inputting device for a notebook computer without increasing the size of the notebook computer so that the independent number and operation inputting device can be used to input numbers and a keyboard of the notebook computer can be used to input characters. Both the independent number and operation inputting device can be matched up to each other in operation. Furthermore, the independent number and operation inputting device is free from the inconvenience of switching continuously from the number input mode to the character input mode so that a standard keyboard almost identically to a keyboard of a personal computer is arranged in a notebook computer with advantages of increment of typewriting speed, convenience in use and reduction of typewriting errors.

To achieve above object, the present invention provides a notebook computer which comprises a keyboard and a touch panel; two sides of the touch panel being installed with plate portions; a receiving groove at one of the plate portions; an independent number input device installed in the receiving groove; a touch panel installed at a top of the number input device; and a shaft serving to connect the movable cover to the plate portion.

The present invention offers a convenient function to input numbers quickly and then avoid the inconvenience of switching inputting modes frequently.

The various objects and advantages of the present invention will be more readily understood from the following detailed description when read in conjunction with the appended drawing.

### BRIEF DESCRIPTION OF THE DRAWINGS

FIG. 1 is a perspective view of a prior art.

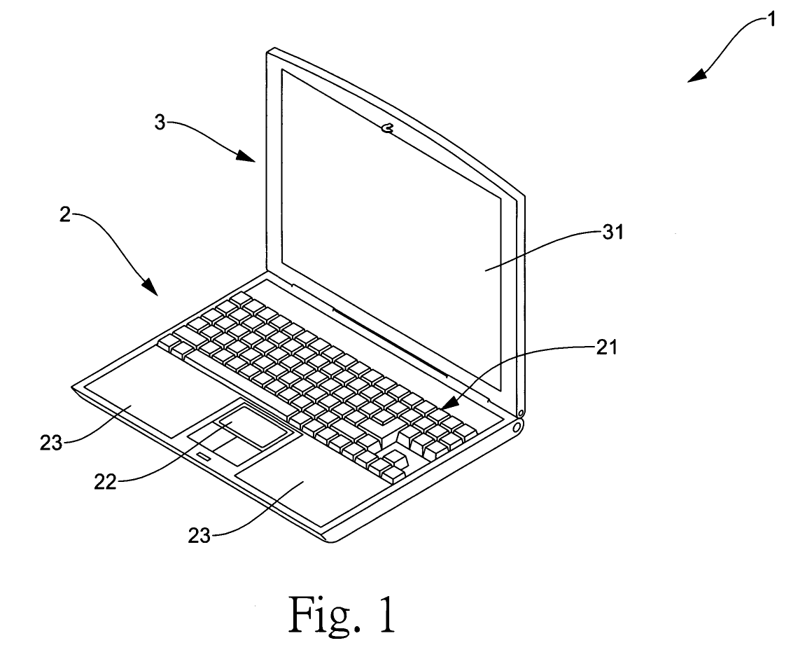

FIG. 2 is a perspective view of the present invention.

FIG. 3 is an upward schematic view of the present invention.

FIG. 4 illustrates an operation of opening the touch panel according to the embodiment of the present invention.

FIG. 5 illustrated an operation of closing the touch panel according to the embodiment of the present invention.

FIG. 6 shows another embodiment of the touch panel of the present invention.

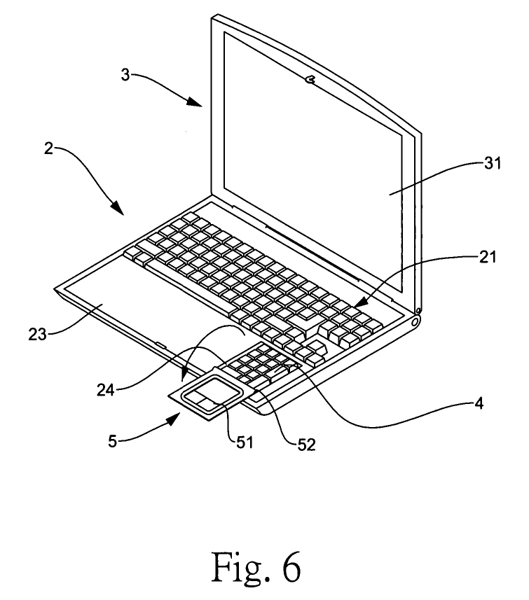

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

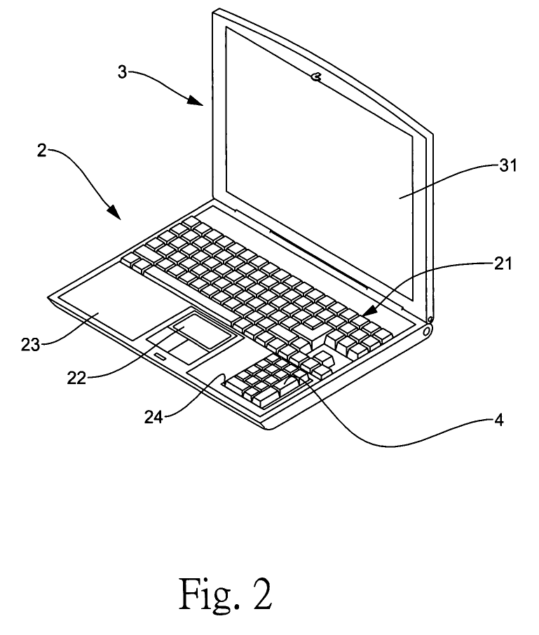

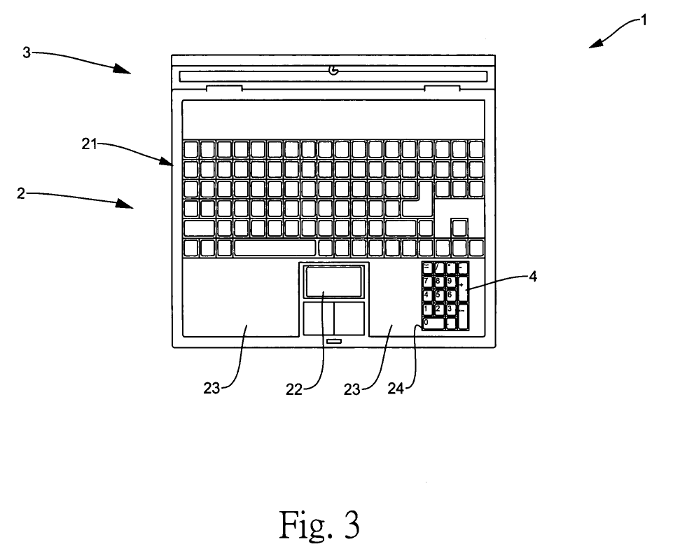

Referring to FIGS. 2 and 3, the notebook computer 1 with an independent number and operation inputting device is illustrated. The notebook computer 1 includes the following elements.

A mainframe body 2 has a keyboard 21 and a touch panel 22. Two sides of the touch panel 22 are installed with plate portions 23.

The display unit 3 has a screen 31.

The features of the present invention will be described in the following. A receiving groove 24 is of one of the plate portions 23. An independent number input device 4 is installed in the receiving groove 24. The number input device 4 includes at least number key about the numbers of 1 to 9 and 0, etc., the operation keys about “+”, “−”, “×” and “/”, etc., and keys of “Num Lock”, “Del”, “Enter”, etc.

By the independent number input device 4, when it is necessary to input characters and numbers to the notebook computer 1 alternatively. If it is desired to input characters, it is only necessary to press the keyboard 21, but if it is desired to input numbers, the user only needs to click the keys of the number input device 4. The operation is convenient.

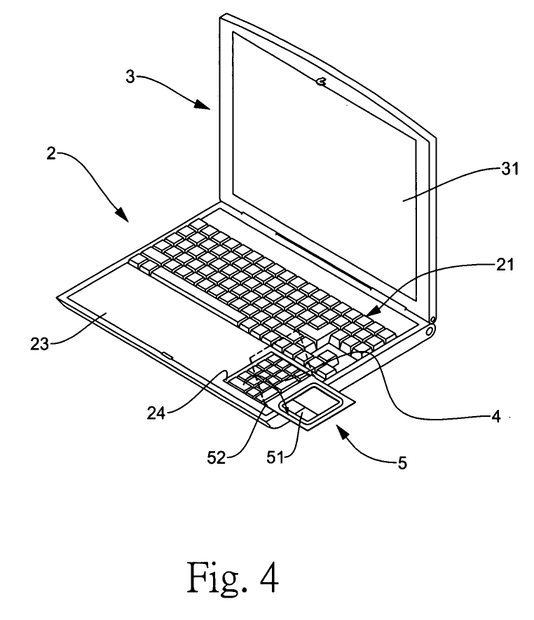

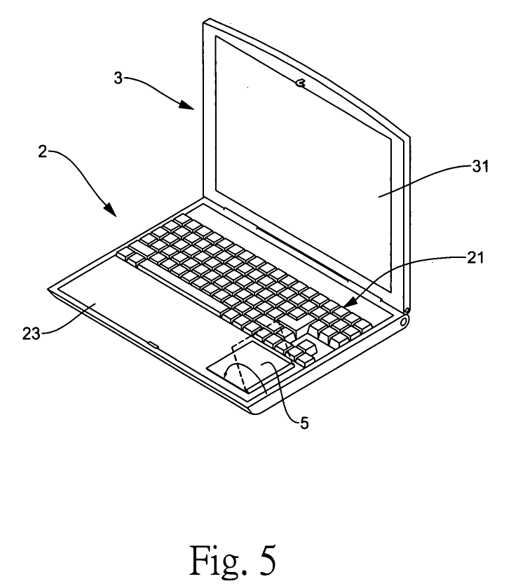

Referring to FIGS. 4 and 5, in the present invention, other than the number input device 4, the touch panel 22 can be removed. A further touch panel 22 is installed at a top of the number input device 4. In this embodiment, the touch panel 51 is installed on a side of a movable cover 5. A shaft 52 serves to connect the movable cover 5 to the plate portion 23. As shown in FIG. 4, when it is desired to use the touch panel 51, the movable cover 5 turns outwards so that the number input device 4 and the touch panel 51 appear. When it is not used, it is only necessary to cover the movable cover 5 upon the number input device 4 of the plate portion 23 so that the plate portion 23 is flushed with the movable cover 5 and the dust will not pollute the touch panel 51 and the number input device 4.

Since the touch panel 51 illustrated in FIG. 4 is installed at a right side of the plate portion 23, it is suitable for right hand users.

The movable cover 5 can be opened or closed by any allowable ways or directions. In FIG. 4, it is illustrated that the movable cover 5 is opened by rightwards turning. In FIG. 5, the movable cover 5 is opened by turning forwards. Other way is also permissible and within the scope of the present invention.

Furthermore, the notebook computer 1 with an independent number and operation inputting device of the present invention can improve the prior art defect in inputting numbers, but not increase the volume of the notebook computer.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claim is:

1. A notebook computer with an independent number and operation inputting device comprising:
a mainframe body installed with a keyboard and two plate portions;
an independent number input device installed in one of the plate portions; and
a display unit being a screen.

2. The notebook computer 1 with an independent number and operation inputting device as claimed in claim 1, wherein the receiving groove is installed at one of two plate portions; and an independent number input device is installed in the receiving groove.

3. The notebook computer 1 with an independent number and operation inputting device as claimed in claim 1, wherein the number input device 4 includes at least a plurality of number keys about the numbers of 1 to 9 and 0, and operation keys about “+”, “−”, “×” and “/”, and keys of “Num Lock”, “Del”, “Enter”.

4. The notebook computer 1 with an independent number and operation inputting device as claimed in claim 1, wherein a movable cover is assembled in the number input device of the plate portions; and a touch panel is assemble inside of the movable cover.

5. The notebook computer 1 with an independent number and operation inputting device as claimed in claim 1, wherein a shaft is installed between the movable cover and the plate portion.
